(19) United States
(12) Patent Application Publication
(10) Pub. No.: US 2026/0129142 A1
(43) Pub. Date: May 7, 2026

(54) ELECTRONIC APPARATUS AND CONTROL METHOD THEREOF

(71) Applicant: SAMSUNG ELECTRONICS CO., LTD., Suwon-si (KR)

(72) Inventors: Minjeong KIM, Suwon-si (KR); Minsang KIM, Suwon-si (KR)

(73) Assignee: SAMSUNG ELECTRONICS CO., LTD., Suwon-si (KR)

(21) Appl. No.: 19/327,307

(22) Filed: Sep. 12, 2025

Related U.S. Application Data
(63) Continuation of application No. PCT/KR2025/012072, filed on Aug. 8, 2025.

(30) Foreign Application Priority Data
Nov. 6, 2024 (KR) 10-2024-0156226

(51) Int. Cl. H04N 5/45; G06T 3/40; G09G 3/36

(52) U.S. Cl. CPC H04N 5/45; G06T 3/40; G09G 3/3618; G09G 2340/0435

(57) ABSTRACT

Disclosed is an electronic apparatus. The electronic apparatus includes an input/output interface, memory configured to store at least one instruction, and at least one processor configured to execute the at least one instruction, and the at least one processor obtains a first image having variable refresh rate through the input/output interface, and based on obtaining a second image having fixed refresh rate, generates a multi-view screen displaying both the first image and the second image, by changing refresh rate of the second image based on current refresh rate corresponding to the variable refresh rate.

### CROSS-REFERENCE TO RELATED APPLICATION

This application is a continuation application of international application No. PCT/KR2025/012072, filed on Aug. 8, 2025, which claims priority under 35 U. S. C. § 119 to Korean Patent Application No. 10-2024-0156226, filed on Nov. 6, 2024, the disclosures of which are incorporated herein by reference in their entireties.

### TECHNICAL FIELD

This disclosure relates to an electronic apparatus capable of processing an image having variable refresh rate and an image having fixed refresh rate as a multi-view screen, and a control method thereof.

### BACKGROUND ART

With the advancement of electronic technologies, various types of electronic devices have been developed and provided. In particular, display devices such as a TV or a mobile device and the like have be developed and provided actively.

As one example, an image could be provided to a display device and the like by using a variable refresh rate (VRR) image signal from a server, a game console and the like.

### DISCLOSURE OF INVENTION

### Solution to Problem

Embodiments according to the present disclosure are to solve at least one of the above-described problems and/or disadvantages and provide advantages. Accordingly, the embodiments are to provide an electronic apparatus capable of processing an image having variable refresh rate and an image having fixed refresh rate as a multi-view screen and a control method thereof.

Embodiments are described in the detailed description provided hereafter, and some of the embodiments are clearly understood from the detailed description, and the other (other) embodiments are suggested based on training from suggested embodiments.

According to an embodiment of the disclosure, an electronic apparatus may include an input/output interface; memory configured to store at least one instruction; and at least one processor configured to execute the at least one instruction to: obtain a first image having a variable refresh rate through the input/output interface, obtain a second image having a fixed refresh rate, and generate a multi-view screen displaying both the first image and the second image by changing the fixed refresh rate of the second image to a current refresh rate of the first image.

According to an embodiment of the disclosure, a method of controlling an electronic apparatus, the method may include: obtaining a first image having a variable refresh rate; obtaining a second image having a fixed refresh rate; and generating a multi-view screen displaying both the first image and the second image, by changing the fixed refresh rate of the second image to a current refresh rate of the first image.

An electronic apparatus according to an embodiment is disclosed. The electronic apparatus includes an input/output interface, memory configured to store at least one instruction, and at least one processor configured to execute the at least one instruction, and the at least one processor obtains a first image having variable refresh rate through the input/output interface, and based on obtaining a second image having fixed refresh rate, generates a multi-view screen displaying both the first image and the second image, by changing refresh rate of the second image based on current refresh rate corresponding to the variable refresh rate.

Based on the refresh rate of the second image being greater than minimum refresh rate of the variable refresh rate, the at least one processor may change the minimum refresh rate of the variable refresh rate of the first image.

The at least one processor may generate the multi-view screen such that refresh rate of the multi-view screen corresponds to refresh rate of the first image.

The at least one processor may synchronize refresh rate such that the refresh rate of the second image corresponds to current refresh rate of the first image by disposing a frame of the second image repeatedly.

The at least one processor may synchronize a Vsync start time point of the first image with a Vsync start time point of the second image by adjusting a vertical front porch Vfront of the second image.

The at least one processor may determine resolution of the multi-view screen, and may scale at least one of resolution of the first image and resolution of the second image in response to the determined resolution of the multi-view screen.

The electronic apparatus may further include a display configured to display an image by using one timing controller, and the at least one processor may control the timing controller to display the multi-view screen.

The electronic apparatus may further include a display configured to display an image by using a plurality of timing controllers, and the at least one processor may change the refresh rate of the second image in a case where at least one timing controller among the plurality of timing controllers processes the first image and the second image together.

The at least one processor may generate the first image and the second image as a multi view in a picture in picture (PIP) form.

The at least one processor may obtain current refresh rate of the first image based on refresh rate information in a video timing extended metadata (VTEM) packet obtained through the input/output interface.

A control method of an electronic apparatus according to an embodiment includes obtaining a first image having variable refresh rate, obtaining a second image having fixed refresh rate, and generating a multi-view screen displaying both the first image and the second image, by changing refresh rate of the second image based on refresh rate corresponding to the variable refresh rate.

The method may further include, based on the refresh rate of the second image being greater than minimum refresh rate of the variable refresh rate, changing the minimum refresh rate of the variable refresh rate of the first image.

The generating a multi-view screen may include generating the multi-view screen such that refresh rate of the multi-view screen corresponds to refresh rate of the first image.

The generating a multi-view screen may include synchronizing refresh rate such that the refresh rate of the second image corresponds to current refresh rate of the first image by disposing a frame of the second image repeatedly.

The generating a multi-view screen may include synchronizing a Vsync start time point of the first image with a Vsync start time point of the second image by adjusting a vertical front porch Vfront of the second image.

The method may further include determining resolution of the multi-view screen, and scaling at least one of resolution of the first image and resolution of the second image in response to the determined resolution of the multi-view screen.

The method may further include outputting the multi-view screen on a display displaying an image by using one timing controller.

The method may further include outputting the multi-view screen on a display displaying an image by using a plurality of timing controllers, and the generating a multi-view screen may include changing the refresh rate of the second image in a case where at least one timing controller among the plurality of timing controllers processes the first image and the second image together.

The generating a multi-view screen may include generating the first image and the second image as a multi view in a PIP form.

In a non-transitory computer-readable recording medium in which a program for executing a control method of an electronic apparatus is stored according to an embodiment, the method includes obtaining a first image having variable refresh rate, obtaining a second image having fixed refresh rate, and generating a multi-view screen displaying both the first image and the second image, by changing refresh rate of the second image based on refresh rate corresponding to the variable refresh rate.

### BRIEF DESCRIPTION OF DRAWINGS

Above-describe aspects, features and advantages or other aspects, features and advantages according to embodiments of the disclosure may be understood more clearly from following descriptions provided with reference to accompanying drawings, wherein:

FIG. 1 is a view provided to explain a multi-view displaying operation according to one embodiment;

FIG. 2 is a block diagram of a configuration of an electronic apparatus according to one embodiment;

FIG. 3 is a block diagram of a configuration of an electronic apparatus according to one embodiment;

FIG. 4 is a flowchart provided to explain a multi-view setting operation by using an image having variable refresh rate according to one embodiment;

FIG. 5 is a view provided to explain a structure of a video timing extended metadata (VTEM) packet according to one embodiment;

FIG. 6 is a view provided to explain a difference between an image of variable refresh rate and an image of fixed refresh rate according to one embodiment;

FIG. 7 is a view provided to explain a method of synchronizing refresh rate according to one embodiment;

FIG. 8 is a view provided to explain a multi-view generating operation from a resolution perspective according to one embodiment;

FIG. 9 is a view provided to explain a multi-view generating operation from a resolution perspective according to one embodiment;

FIG. 10 is a view provided to explain a multi-view disposing structure according to one embodiment;

FIG. 11 is a view provided to explain a multi-view disposing structure according to one embodiment;

FIG. 12 is a view provided to explain a multi-view displaying operation in a case where a plurality of TCONs is provided according to one embodiment;

FIG. 13 is a view provided to explain a multi-view displaying operation in a case where a plurality of TCONs is provided according to one embodiment; and

FIG. 14 is a flowchart provided to explain a control method of an electronic apparatus according to one embodiment.

### MODE FOR INVENTION

Embodiments of the present disclosure may be modified in various different forms, and may vary. Accordingly, specific embodiments are illustrated in the drawings, and specifically described in the detailed description. However, it is to be understood that the scope of the disclosure is not limited to the specific ones and that embodiments of the disclosure are to be interpreted as including various modifications, equivalents and/or alternatives of the embodiments set forth herein. In the drawings, like reference numerals may be used to indicate like elements.

In describing the disclosure, in case detailed descriptions of known functions or configurations to which the disclosure pertains make the gist of the disclosure unnecessarily vague, detailed descriptions thereof are omitted.

Additionally, the embodiments described hereinafter may be modified in various different forms, and it is to be understood that the scope of the technical spirit of the disclosure is not limited to the embodiments. Rather, the embodiments are provided to make the disclosure thorough and complete and to fully convey the technical spirit of the disclosure to those skilled in the art.

Terms set forth herein are merely used to describe specific embodiments, and are not intended to limit the scope of the rights for which protection is sought. Unless explicitly stated otherwise, singular forms include plural forms as well.

In the disclosure, expressions such as “have,” “may have,” “include,” or “may include,” and the like are used to indicate the presence of a corresponding feature (e.g., elements such as a numerical value, a function, an operation, or a component and the like), and do not imply exclusion of the presence of additional features.

In the disclosure, expressions such as “A or B,” “at least one of A or/and B,” or “one or more of A or/and B”, and the like may include all possible combinations of the items listed together. For example, “A or B,” “at least one of A and B,” or “at least one of A or B” may refer to all cases including (1) at least one A, (2) at least one B, or (3) both of at least one A and at least one B.

In the disclosure, expressions such as “1st”, “2nd”, “first”, or “second”, and the like may be used to refer to various elements regardless of their order and/or importance, and may be merely used to differentiate one element from another but not intended to limit the elements.

Based on one element (e.g., a first element) referred to as being “(operatively or communicatively) coupled with/to or connected with/to” another element (e.g., a second element), it is to be understood that one element may be connected to another element directly or through yet another element (e.g., a third element).

On the other hand, based on one element (e.g., a first element) referred to as being “directly coupled with/to” or “directly connected with/to” another element (e.g., a second element), it is to be understood that yet another element (e.g., a third element) is not present between one element and another element.

The expression “configured to (or set to) . . . ” used herein may be used interchangeably with, for example, “suitable for . . . ,” “having the capacity to . . . ,” “designed to . . . ,” “adapted to . . . ,” “made to . . . ,” or “capable of . . . ” depending on circumstances. The term “configured to (or set to) . . . ” may not necessarily mean “specifically designed to . . . ” in a hardware manner.

Rather, in a certain situation, the expression “a device configured to . . . ” may mean “capable of performing” by the device together with another device or other components. For example, the phrase “a processor configured (or set) to perform A, B and C” may mean an exclusive processor (e.g., an embedded processor) for performing the functions, or a generic-purpose processor (e.g., a CPU or an application processor) capable of performing the functions by executing one or more software programs stored in a memory device.

In the embodiments, the term “module” or “unit” may perform at least one function or operation, and be implemented by hardware or software or by a combination of hardware and software. Additionally, multiple “modules” or multiple “units” may be integrated into at least one module and be implemented as at least one processor except for a “module” or a “unit” that needs to be implemented by specific hardware.

Operations performed by a module, a program, or another element, according to the embodiments, may be executed sequentially, in parallel, repetitively, or heuristically, or at least part of the operations may be executed in a different order, may be omitted, or may add a different operation.

Meanwhile, various elements and regions in the drawings are schematically illustrated. Accordingly, the technical spirit of the disclosure is not limited by relative sizes or distances illustrated in the accompanying drawings.

Meanwhile, an electronic apparatus according to the embodiments of the disclosure may include at least one of a terminal device, a tablet PC, a desktop PC, a laptop PC, a server, or a wearable device, for example. The wearable device may include at least one of an accessory-type wearable device (e.g., a watch, a ring, a bracelet, an anklet, a necklace, glasses, contact lenses or a head-mounted-device (HMD)), a fabric or cloth-integrated wearable device (e.g., electronic cloth), a body-attachable wearable device (e.g., a skin pad or tattoo), or implantable circuitry.

In some embodiments, the electronic apparatus, for example, may include at least one of a television, a digital video disk (DVD) player, an audio, a refrigerator, an air conditioner, a vacuum cleaner, an oven, a microwave oven, a washing machine, an air purifier, a set-top box, a home automation control panel, a security control panel, a media box (e.g., Samsung HomeSync™, Apple TV™, or Google TV™), a game console (e.g., Xbox™, PlayStation™), an electronic dictionary, an electronic key, a camcorder, or an electronic picture frame. Meanwhile, among the above-described electronic apparatuses, a device provided with a display may be referred to as a display device. Meanwhile, the electronic apparatus according to the disclosure may be a set-top box or a PC or a game console that provides an image to a display device, although the electronic apparatus is not provided with a display device.

Hereinafter, the embodiments of the disclosure are described specifically with reference to the accompanying drawings such that those skilled in the art to which the disclosure pertains may readily implement the embodiments.

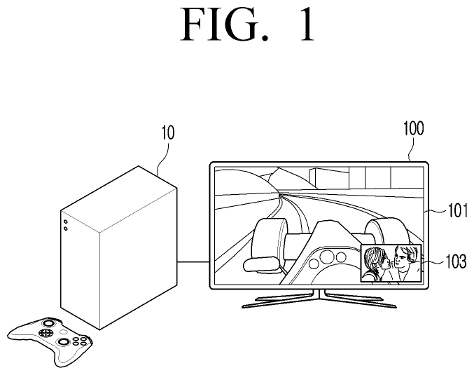

FIG. 1 is a view provided to explain a multi-view displaying operation according to one embodiment.

Referring to FIG. 1, an electronic apparatus 100 may display a screen corresponding to an image. Herein, the screen includes an image displayed on a display of the electronic apparatus 100. The image may also be referred to as a term such as a frame and the like. On the screen, various types of objects such as an icon, a text, a picture, a moving image, a widget and the like may be displayed.

Meanwhile, in the illustrative example, it is assumed that the electronic apparatus 100 directly displays an image for convenience of description, but when implemented, the electronic apparatus 100 may be an apparatus that is provided with no display and outputs an image to another apparatus.

Additionally, the electronic apparatus 100 may display a multi-view screen on which a plurality of images 101, 103 is displayed at a time. Herein, the multi-view screen is to constitute a screen enabling the user to view two or more contents at the same time. The multi-view screen may also be referred to as a multiple screen, a double screen and the like.

Further, the contents are comprised of images, audios or a combination thereof, and includes information that may be provided to the user visually, acoustically, or audiovisually through the electronic apparatus. The contents, for example, may include voice contents, music contents, image contents, moving image contents, widget contents, webpages and the like.

Furthermore, each of the contents may be obtained through an identical source provider (e.g., an HDMI, internet networks, broadcasting and the like), and may be obtained through another source provider. For example, a first image may be obtained through an HDMI terminal, while a second image may be obtained through a broadcasting signal or a USB 3.1 terminal.

In the illustrative example, an example of a multi-view screen on which two images are disposed in a picture in picture (PIP) form is illustrated. However, when implemented, a size of each of the images may be equal, and three or more images may be used. Herein, the PIP form is one layout of a multi view where a sub image is additionally disposed in a main image.

Meanwhile, a source device 10 has supported a variable refresh rate (VRR) recently. The VRR may also be referred to as variable refresh rate or a variable refresh rate, and the like, and may denote a dynamic displaying method by which a refresh rate may continue to be changed automatically and smoothly although the user does not change the refresh rate.

The VRR supports a normal refresh rate range (e.g., 30 Hz-144 Hz), and the refresh rate is referred to as a VRR range (or a refresh rate range).

The refresh rate may be referred to as a speed at which a display displays data of one screen, and may also be referred to as a frame rate, refresh rate, a refresh rate, a frame speed, a screen frame rate or a screen refresh rate and the like. For example, frames per second may indicate the number of screens viewed for one second, and may use a unit of fps (frame/second).

Accordingly, fixed refresh rate means that refresh rate remains constant while an image is displayed, and variable refresh rate means that refresh rate is changed while an image is displayed.

In the case of VRR, despite a change in frame frequency, which is caused by complexity of rendering while game contents are displayed, refresh rate of a display may be changed in response to the change. Accordingly, by matching a refresh rate of an image provided based on the VRR method with a frame provided from a source provider, the electronic apparatus 100 may output a screen smoothly without causing visual issues like tearing or stuttering.

In the case where the VRR function is proceeding, a multi-view operation may not be performed conventionally. This is because two different images displayed together have different refresh rate, while the electronic apparatus has difficulty in processing the images with two different refresh rate at the same time.

Specifically, in the case where the electronic apparatus controls the display by using one timing controller, the electronic apparatus may not process two images having different refresh rate together considering the one timing controller operates with one refresh rate.

For example, in the case of a display having one timing controller, refresh rate (or a refresh rate) and resolution of each source may not be adjusted independently despite an input of an HDMI VRR signal. Accordingly, an existing electronic apparatus (or a display device) limits the use of an HDMI VRR signal in a multi-view situation.

Meanwhile, even in the case of a display using a plurality of timing controllers, the number of images needs to correspond to the number of timing controllers, and a display area also needs to be limited to an area of a timing controller.

That is, even in the case where two timing controllers are provided, the two timing controllers may not be applied when two images 101, 103 are displayed in the PIP form as shown in FIG. 1. Additionally, in the case where the number of timing controllers is less than the number of images displayed together, the timing controllers may also not operate. For example, in the case where there are three images while there are two timing controllers, the timing controllers may not operate.

To solve the problem, the electronic apparatus 100 according to the disclosure supports a method of displaying an image having variable refresh rate and an image having fixed refresh rate as a multi view.

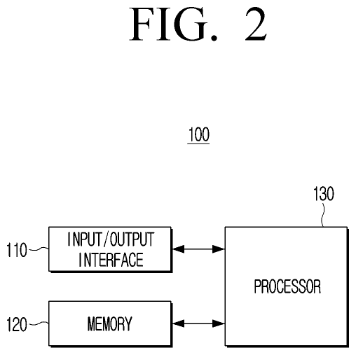

For example, the electronic apparatus 100 obtains current refresh rate of a first image 101 having variable refresh rate, allows refresh rate of a second image 103 to have the current refresh rate of the first image 101, and generates a multi-view screen by combining the two images having identical refresh rate. A detailed configuration and operation of the electronic apparatus 100 are described hereafter with reference to FIG. 2.

Meanwhile, in the illustrative example, two screens are combined, but when implemented, three or more images may be combined as a multi view. Additionally, a form of a combined layout may use various forms as well as the PIP form.

The above-described electronic apparatus according to the disclosure may generate a multi-view screen of an image having variable refresh rate and an image having fixed refresh rate, thereby securing improvement in user experience.

FIG. 2 is a block diagram of a configuration of an electronic apparatus according to one embodiment.

Referring to FIG. 2, the electronic apparatus 100 may include an input/output interface 110, memory 120 and a processor 130.

The input/output interface 110 may be any one of a High-Definition Multimedia Interface (HDMI), a Mobile High-Definition Link (MHL), Universal Serial Bus (USB), Display Port (DP), Thunderbolt, a Video Graphics Array (VGA) port, an RGB port, D-subminiature (D-SUB), a Digital Visual Interface (DVI).

The input/output interface 110 may input and output at least one of an audio signal and a video signal. Depending on embodiments, the input/output interface 110 may separately include a port inputting and outputting an audio signal only, and a port inputting and outputting a video signal only, or may be implemented as one port inputting and outputting both the audio signal and the video signal.

The input/output interface 110 may include at least one port, and a plurality of ports. In the case where the input/output interface 110 includes a plurality of ports, the input/output interface 110 may receive different images from different ports.

Additionally, the input/output interface 110 may provide, to an external device (e.g., a display device, an STB and the like), a video signal corresponding to a screen generated by the electronic apparatus 100 or an audio signal together with the video signal. Herein, the generated screen may be a multi-view screen.

For example, an image may be input through one port, while a multi-view screen may be output through another port. For example, the input/output interface 110 may receive a first image having variable refresh rate through a first port, and may output a multi-view screen having variable refresh rate and the first image and the second image are combined through a second port. At this time, part of the plurality of ports may support an identical interface method, and at least two of the ports may support interface methods that are different from each other.

To this end, at least one port of the input/output interface 110 may support an interface method supporting variable refresh rate. For example, the interface method supporting variable refresh rate may be an HDMI 2.1 display port.

The memory 120 may store instructions, programs or data for controlling the electronic apparatus 100. Herein, the instructions may include an instruction for receiving and transmitting a source provider and an image of variable refresh rate, an instruction for generating a multi-view screen, an instruction for changing refresh rate of an image having fixed refresh rate, and the like.

For example, the memory 120 may be implemented as internal memory such as ROM (e.g., electrically erasable programmable read-only memory (EEPROM)), RAM and the like included in the processor 130, or memory separate from the processor 130. In this case, the memory 120 may be implemented in the form of memory embedded in the electronic apparatus 100, or in the form of memory detachable from the electronic apparats 100 depending on a data storage purpose. For example, data for driving the electronic apparatus 100 may be stored in memory embedded in the electronic apparatus 100, and data for an extension function of the electronic apparatus 100 may be stored in memory detachable from the electronic apparatus 100. Meanwhile, the memory embedded in the electronic apparatus 100 may be implemented as at least one of volatile memory (e.g., dynamic RAM (DRAM), static RAM (SRAM) or synchronous dynamic RAM (SDRAM), and the like), or non-volatile memory (e.g., one time programmable ROM (OTPROM), programmable ROM (PROM), erasable and programmable ROM (EPROM), electrically erasable and programmable ROM (EEPROM), mask ROM, flash ROM, flash memory (e.g., NAND flash or NOR flash and the like), hard drive, or solid-state drive (SSD)), while the memory detachable from the electronic apparatus 100 may be implemented in the form of a memory card (e.g., compact flash (CF), secure digital (SD), micro secure digital (Micro-SD), mini secure digital (Mini-SD), extreme digital (xD), a multi-media card (MMC) and the like), external memory (e.g., USB memory) connectable to a USB port, and the like.

The memory 120 may store a first image obtained through the input/output interface 110 temporarily, or store a multi-view screen generated in a process described hereafter. Additionally, the memory 120 may store contents corresponding to a second image or the second image.

Further, the memory 120 may store various types of contents (e.g., broadcasting contents, applications and the like) received through a communication unit 150 described hereafter.

Meanwhile, in the illustrative example, the electronic apparatus 100 is comprised of one memory, but in the case where volatile memory and non-volatile memory are referred to in a differentiated manner, the electronic apparatus 100 may also be referred to as including a plurality of memories.

The processor 130 controls entire operations of the electronic apparatus 100. Specifically, the processor 130 may be connected to an element of an electronic apparatus including the memory 120, and control the entire operations of the electronic apparatus by executing at least one instruction stored in the above-described memory 120. In particular, the processor 130 may be implemented as a plurality of processors 130 as well as one processor 130.

The processor 130 may be implemented as one or more integrated circuit (or circuitry) chips, and execute various types of data processing. The processor 130 may include at least one electrical circuit, and perform distribution processing of instructions (or programs, data and the like) stored in the memory individually or collective.

The processor 130 may include a processor set including one or more processing circuits. The processor 130 may include any processing circuit operative to control performance and operations of one or more elements (e.g., memory and/or a driving device (a sensor)) of an electronic apparatus. For example, the processor 130 (e.g., AP) may be implemented as a system on a chip (SoC; e.g., one chip or one chip set). For example, the processor 130 may be implemented as a plurality of cores (or at least one core circuit), a plurality of chips or a plurality of chip sets.

For example, the processor 130 may include one or more processing circuits. Additionally, the processor 130 may include one or more processing circuits configured to perform various functions of the disclosure individually and/or collectively. As a non-limited example, at least part of the processor 130 may be included in a first chip of the electronic apparatus 100, and at least the other part of the processor 130 may be included in a second chip of the electronic apparatus 100, which is different from the first chip of the electronic apparatus 100.

For example, the processor 130 may include a central processing unit (CPU), a graphics processing unit (GPU), a neural processing unit (NPU), an image signal processor (ISP), a display controller, a memory controller, a storage controller, a communication processor (CP) and/or a sensor interface. The above-described elements of the processor 130 are described merely as examples. The processor 130 may further include other elements in addition to the above-described elements. Additionally, part of the elements of the processor 130 may be omitted. Further, part of the elements of the processor 130 may be included as a separate element of an electronic apparatus 100 outside the processor 130. For example, part (e.g., a memory controller) of the elements of the processor 130 may be included in other elements (e.g., at least part of memory, an interface (e.g., used to connect to at least one element of an electronic apparatus 100), a display).

The processor 130 may cause the other elements of the electronic apparatus 100 to perform various operations by executing instructions stored in the memory.

The processor 130 may process a set value, a function instruction and the like based on a pre-stored control program or control data, and output a control signal in association with functions performable by the electronic apparatus or a communication signal for communicating with an external electronic apparatus.

The processor 130 may obtain a first image by using the input/output interface 110. At this time, the obtained first image may be an image having variable refresh rate. Based on receiving a multi-view displaying instruction during a display or processing of the first image, the processor 130 may obtain a second image to be included in the multi-view screen based on user's selection.

For example, the second image may be an image obtained through another port in an identical input/output interface 110, and may be contents pre-stored in the memory 120 or an image obtained through the communication unit 150 described hereafter.

Meanwhile, when implemented, after receiving a multi view display command, a first image (or source source) can be selected. In this case, the processor 130 can determine whether the first image is an image with a variable refresh rate or an image with a fixed refresh rate.

In the case where the multi-view displaying instruction is input as described above, the processor 130 may determine a source provider belonging to a multi view, and determine a display layout of each source provide. For example, in the case where two screens need to be displayed, the processor 130 may determine whether the two screens are displayed equally or in the PIP form. Additionally, even in the case where the layout is determined, the processor 130 may determine which of two areas is disposed by the first image or the second image, and the like.

The above-described determination may be based on selection of the user, and performed based on results of pre-selection of the user or a way of last-minute use and the like. For example, the user uses a last-minute multi view as a PIP, and first selects an image of variable refresh rate, the image selected first may be used as a main image. Then an image selected later may be used as a sub image. If there is the above-described selection process, the processor 130 may determine to dispose the first image to the background of a PIP image and dispose the second image to a picture area.

Additionally, the processor 130 may check whether there is an image having variable refresh rate among sources constituting a multi view. For example, in the case where at least one of the sources is obtained through the input/output interface, the processor 130 may check whether the source has variable refresh rate by using an enable signal VRR_EN in a video timing extended metadata (VTEM) packet.

If all the sources have fixed refresh rate, the processor 130 may generate a multi-view screen based on an operation such as an operation of changing resolution and the like without an additional operation of synchronizing (or matching) refresh rate.

Herein, the resolution may be information on the number of pixels included in the screen of a display, and may be represented based on the number of pixels in the horizontal direction of the display and the number of pixels in the vertical direction of the display. In one example, the resolution may be the number of pixels displayed on a screen at the same time, i.e., a value of multiplication of the number of pixels in the horizontal direction and the number of pixels in the vertical direction.

For example, the resolution may include standard definition (SD), high definition (HD), full high definition (FHD), quad high definition (QHD), 4K ultra high definition (UHD), 8K ultra high definition (UHD), or greater. In the case of a screen of resolution of “1920×1080”, the screen has 1,920 pixels in the horizontal direction thereof, while the screen has 1,080 pixels in the vertical direction thereof. Accordingly, a total of 2,073,600 pixels may be included on the screen.

Additionally, the processor 130 may check a frequency range (or a range) of an image having variable refresh rate and a refresh range of an image having fixed refresh rate. If refresh rate of a second image is greater than minimum refresh rate of variable refresh rate, the processor 130 may change minimum refresh rate of the variable refresh rate of a first image. On the contrary, if the minimum refresh rate is greater than the refresh rate of the second image, the minimum refresh rate may not be changed.

If one of a plurality of sources has variable refresh rate, the processor 130 may perform an operation of changing refresh rate of an image having fixed refresh rate. For example, the processor 130 may generate a multi-view screen where the first image and the second image are displayed together by changing the refresh rate of the second image based on current refresh rate corresponding to the variable refresh rate. Accordingly, the generated multi-view screen has refresh rate identical with the refresh rate of the first image.

For the above-described operation to be performed, the processor 130 may identify the current refresh rate of the first image of the variable refresh rate. Specifically, the processor 130 may obtain the current refresh rate of the first image based on refresh rate information in the VTEM packet obtained through the input/output interface.

Based on checking the current refresh rate of the first image, the processor 130 may synchronize the refresh rate such that the refresh rate of the second image may correspond to current refresh rate of the first image by disposing a frame of the second image repeatedly. Accordingly, the refresh rate of the multi-view screen may be identical with the refresh rate of the first image. Herein, the synchronization of the refresh rate may involve matching Vsync in each frame, as well as matching frames per second (or a refresh rate) of two images.

Meanwhile, disposing the frame of the second image repeatedly is merely described above, but instead of disposing the frame repeatedly, a frame generated by performing frame interpolation may also be used.

Additionally, in the case where the number of frames of the second image becomes identical with the number of frames of the first image as described above, the processor 130 may synchronize a Vsync start time point of the first image and a Vsync start time point of the second image, by adjusting a vertical front porch Vfront of the second image. That is, even in the case where the number of the frames of the first image and the number of the frames of the second image are identical, different start time points Vsync of the two images may cause flickers. Accordingly, the processor 130 may perform synchronization such that two frames may have Vsyn at an identical time point.

Herein, Vsync as vertical synchronization is a signal indicating a frame start. Additionally, Vfront is a section between an end section of a frame and a start of a vertical synchronization Vsync signal.

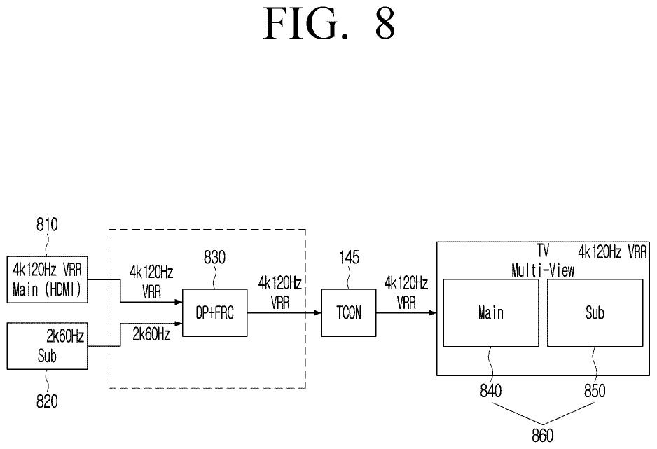

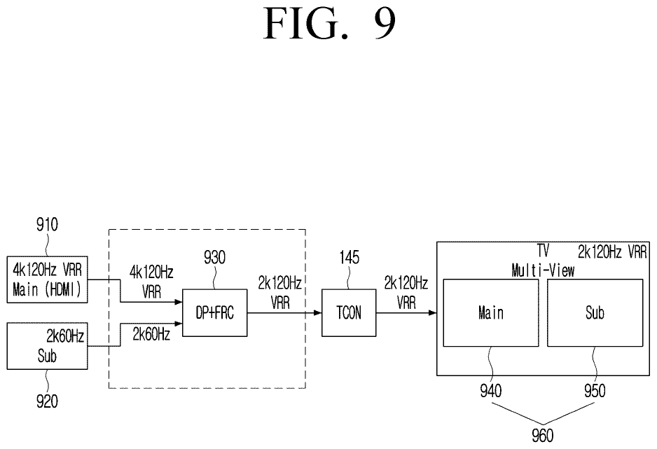

Additionally, the processor 130 may determine resolution of the multi-view screen, and may scale at least one of resolution of the first image and resolution of the second image in response to the determined resolution of the multi view screen. Description of the above-described operation is provided hereafter with reference to FIG. 8 and FIG. 9.

Herein, the scaling may include an operation of changing resolution of an image. Upscaling may be used to change a source of low resolution to an image of high resolution in the way that a new pixel is fitted between pixels to increase resolution. The upscaling may be performed considering a screen ratio of an input image and a screen ratio of a display to be displayed and the like.

Unlike the upscaling, downscaling may include a technology for changing a source of high resolution to a source of low resolution. For example, the scaling may include AI scaling using an artificial intelligence (AI) technology and non-AI scaling. The non-AI scaling may include nearest neighbor, bilinear, bicubic, Lanczos, spline, NGU, and the like.

Such scaling may also be performed in the case where resolution of a first image, resolution of a second image and resolution of a multi view screen are identical. For example, as the multi view proceeds, since the size of an image displayed on a screen may be changed, a scaling operation (or an image editing operation) based on the change may be applied.

The processor 130 may proceed with various types of image processing. For example, a task such as a task of correcting colors of two images similarly, or a task of correcting brightness of two images similarly and the like may be performed. Such a task may proceed individually for each image, or may proceed after a multi-view screen is generated.

In the case where a multi-view screen is generated, the processor 130 may control the input/output interface 140 to output the multi-view screen. Additionally, the processor 130 may generate a VTEM packet of the screen and transmit the VTEM packet to the display. Meanwhile, considering that the refresh rate according to the disclosure is identical with the refresh rate of the first image, the processor 130 may also transmit, to a source device, the VTEM of the first image as it is.

Meanwhile, in the case of an electronic apparatus 100 provided with a display, the electronic apparatus may display a multi-view screen. When implemented, the electronic apparatus may also display an image on the display therein while transmitting the image to an external device.

The electronic apparatus according to the disclosure may generate a multi-view screen of an image having variable refresh rate and an image having fixed refresh rate as described above, securing improvement in user experience.

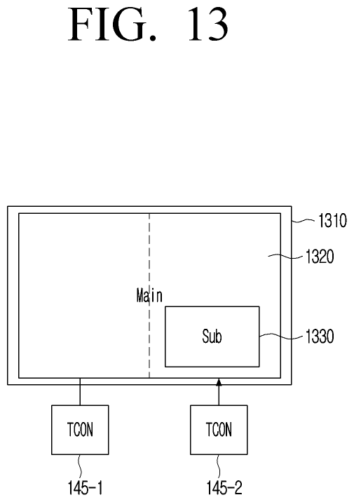

Meanwhile, the operations of the electronic apparatus 100 are described above under the assumption that one of a plurality of source providers has variable refresh rate, but the operations according to the disclosure may also be performed even in the case where two images have variable refresh rate. Description in relation to this is provided hereafter with reference to FIG. 13.

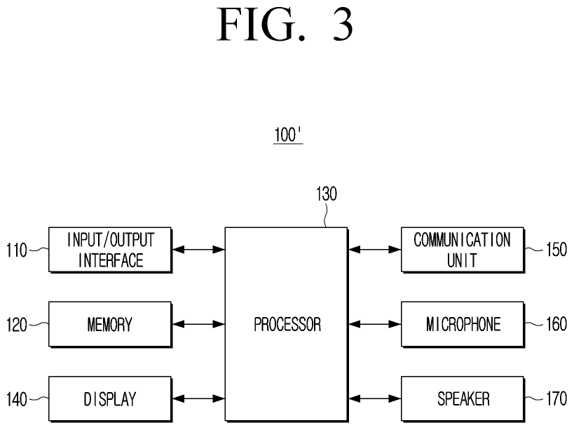

Meanwhile, simple elements constituting the electronic apparatus 100 are illustrated and described above, but when implemented, various types of elements may be additionally provided. Description in relation to this is provided hereafter with reference to FIG. 3.

FIG. 3 is a block diagram of a configuration of an electronic apparatus according to one embodiment.

Referring to FIG. 3, the electronic apparatus 100 may include an input/output interface 110, memory 120, a processor 130, a display 140, a communication unit 150, a microphone 160 and a speaker 170.

The configurations of the input/output interface 110, the memory 120 and the processor 130 are described above with reference to FIG. 2. Accordingly, operations different from those of FIG. 2 are only described hereafter.

The display 140 may be implemented as various types of displays such as a liquid crystal display (LCD), an organic light emitting diode (OLED) display, a plasma display panel (PDP), a micro LED and the like. In the display 140, driving circuitry implementable in the form of an a-si TFT, a low temperature poly silicon (LTPS) TFT, an organic TFT (OTFT) and the like, a backlight unit, and the like may be included together. Meanwhile, the display 140 may be implemented as a touch screen coupled with a touch sensor, a flexible display, a three-dimensional (3D) display, and the like.

The display 140 may display various types of images. For example, the display 140 may display a first image, a second image, a multi view and the like that are generated by the processor 130.

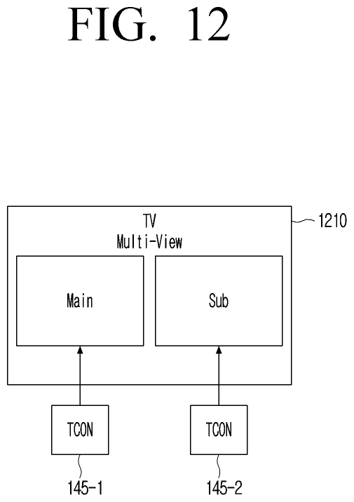

The display 140 may include a timing controller for controlling a plurality of pixels. For example, the display 140 may include one timing controller, or include a plurality of timing controllers. Operations in the case of a display 140 including a plurality of timing controllers are described hereafter with reference to FIGS. 12 and 13.

The communication unit 150 is an element performing communication with various types of external devices based on various communication methods. The communication unit 150 may include a Wi-Fi module, a Bluetooth module, an infrared communication module and a wireless communication module and the like. Herein, each communication module may include at least one hardware chip or hardware circuit.

The Wi-Fi module and the Bluetooth module may perform communication respectively based on a Wi-Fi method and a Bluetooth method. In the case where the Wi-Fi module or the Bluetooth module is used, various types of connection information such as an SSID, a session key and the like may be first transmitted and received, and are used to perform communication connection and then transmit and receive various types of information.

The infrared communication module performs communication based on an infrared Data Association (IrDA) communication technology which transmits data wirelessly over a short distance using infrared rays between visible light and millimeter waves.

In addition to the above-described communication methods, the wireless communication module may include at least one communication chip that performs communication according to various wireless communication standards such as Zigbee, 3rd Generation (3G), 3rd Generation Partnership Project (3GPP), Long Term Evolution (LTE), LTE Advanced (LTE-A), 4th Generation (4G), 5th Generation (5G) and the like.

In addition, the communication unit 150 may include at least one of wired communication modules that perform communication by using a local area network (LAN) module, an Ethernet module, pair cables, coaxial cables, fiber optic cables, or an Ultra Wide-Band (UWB) module and the like.

In one example, the communication unit 150 may use an identical communication module (e.g., a Wi-Fi module) to perform communication with an external device such as a remote controller and an external server.

In another example, the communication unit 150 may use a different communication module (e.g., a Wi-Fi module) to perform communication with an external device such as a remote controller and an external server. For example, the communication unit 150 may use at least one of the Ethernet module or the Wi-Fi module to perform communication with an external server, or may use a BT module to perform communication with an external device such a remote controller. However, this is described merely as an example, and the communication unit 150 may use at least one of various types of communication modules in the case where the communication unit 150 performs communication with a plurality of external devices or external servers.

The communication unit 150 may receive contents, or receive images corresponding to the contents. The contents may include various types of contents such as movies, music videos, dramas, shorts and the like. Additionally, it may be assumed that the contents are moving images, but the contents may also be referred to as images or moving images.

Meanwhile, the above-described images may be images of fixed refresh rate or images of variable refresh rate. That is, in FIG. 2, the first image, i.e., an image having variable refresh rate, may be received through the input/output interface 110, but when implemented, may also be received thought the communication unit. For example, considering that a technology for transmitting and receiving signals and the like of an HDMI and the like wirelessly has been applied recently, the communication unit 150 may obtain the first image in the case where the HDMI is transmitted wirelessly.

Meanwhile, the communication unit 150 may receive broadcasting signals, and obtain broadcasting images based on the received broadcasting signals. Herein, the broadcasting signals may be signals according to a terrestrial digital multimedia broadcasting (DMB) standard, or signals according to a terrestrial ultra-high definition broadcasting standard.

Additionally, the communication unit 150 may receive various types of applications of the electronic apparatus 100 and information needed to provide services and the like from an external device.

The microphone 160 may receive a voice of the user in an activated state. For example, the microphone 160 may be integrally formed on an upper side or in a front surface direction, in a lateral surface direction and the like of an electronic apparatus 100′.

The microphone 160 may include various types of elements such as a microphone collecting a user voice in an analogue form, amp circuitry amplifying the collected user voice, A/D conversion circuitry sampling the amplified user voice and converting the same into a digital signal, and filter circuitry removing a noise component from the converted digital signal, and the like.

In the case where a user voice is input through the microphone 160, the processor 130 may check contents of the user voice, and perform an operation corresponding to the voice contents. For example, the voice contents may be an instruction to proceed with a multi view, or selection of a source used for a multi view.

Further, when implemented, the processor 130 may receive a layout of the multi view selected by the user, and change a way of displaying based on the layout selected by the user. For example, while the first image is displayed on a left side of the multi-view screen and the second image is displayed on a right side of the multi-view screen, the processor may display the first image on the right of the multi-view screen and display the second image on the left side of the multi-view screen in response to a user instruction.

Alternatively, while the first image is displayed on a left side of the multi-view screen and the second image is displayed on a right side of the multi-view screen, the processor 130 may also use the first image as a main image and display the second image as a PIP sub screen in response to a user instruction.

Meanwhile, the input of a user voice through the microphone 160 is described above, but the microphone may be provided at a remote controller for controlling the electronic apparatus 100′, and the user voice input through the microphone provided at the remote controller may be input to the electronic apparatus 100′ through the above-described communication unit 150 and may be processed.

The electronic apparatus 100′ may operate according to a control instruction of a terminal device, as well as operating based on an element or a remote controller provided to the electronic apparatus 100′. For example, in the case where the electronic apparatus is a TV or a set-top box, an application for controlling the TV or the set-top box is provided recently by each manufacturer. Through the application, the terminal device may be used in the same way that the remote controller of the electronic apparatus is used.

Accordingly, in the case where the application is executed and then the user inputs a voice instruction through the terminal device such that the user may control the TV or the set-top box by using the terminal device, the electronic apparatus 100′ may perform a voice recognition operation and obtain voice recognition results corresponding to the voice recognition operation by using a voice signal input through the terminal device.

The speaker 170 may output a sound. Specifically, the speaker 170 may be an element that outputs various types of notification sounds or voice messages and the like as well as various types of audio data processed in the input/output interface.

The processor 130 may select an image to which a sound is to output among a plurality of images, and control the speaker 190 such that the sound corresponding to the image may be output. For example, in the case where a multi view is executed, the processor 130 may control the speaker 170 such that a sound corresponding to a main image may be output among the plurality of images.

Additionally, based on a sound transition instruction of the user, the processor 130 may control the speaker 170 such that a sound corresponding to a sub image may be output.

Additionally, the speaker 170 may also output information on the results corresponding to the voice recognition operation described hereafter.

Meanwhile, the electronic apparatus 100 including a display 140 is illustrated in FIG. 3 and described with reference to FIG. 3, but in the case where the electronic apparatus 100′ is a device such as a set-top box including no display, a display element may be omitted. Further, the above-described speaker and microphone may also be omitted based on the way in which the electronic apparatus 100′ is implemented. Furthermore, though not illustrated in FIG. 3, the electronic apparatus 100′ may further include another element (e.g., a camera) and the like.

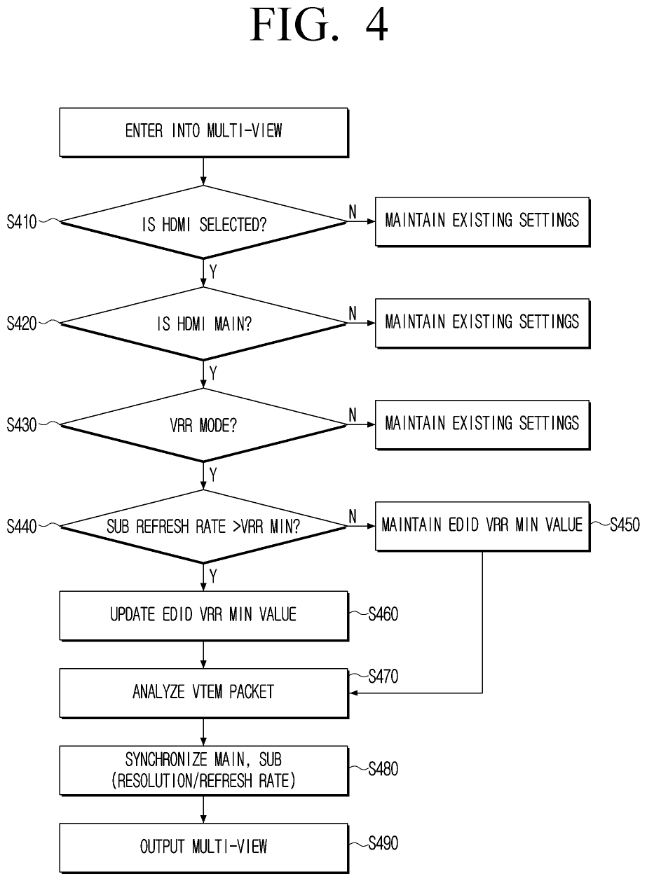

FIG. 4 is a flowchart provided to explain a multi-view setting operation by using an image having variable refresh rate according to one embodiment.

Referring to FIG. 4, in the case where the user selects multi-view settings first, the electronic apparatus 100 may check whether an HDMI is one of sources (S410). Meanwhile, in the illustrative example, as long as the source is a source supporting variable refresh rate as well as an HDMI, a display port or another interface may be applied.

Additionally, the electronic apparatus 100 may check whether an HDMI source is set as a main source (S420). Meanwhile, even in the case where the HDMI source is set as a sub source when implemented, the operation of the present disclosure can be performed. Accordingly, when implemented, checking whether the HDMI source is a main source or not may also be omitted.

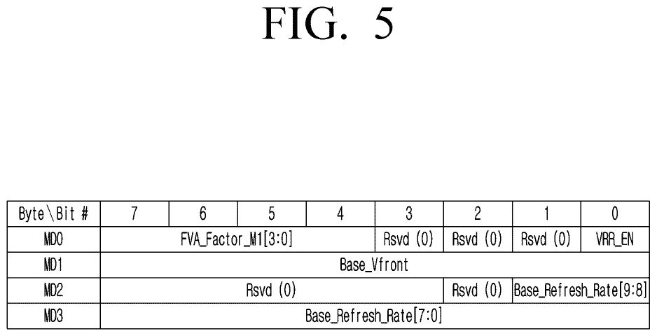

Additionally, the electronic apparatus 100 may check whether the HDMI source has variable refresh rate (S430). Specifically, the electronic apparatus 100 may check whether the HDMI source is operating with variable refresh rate by checking VRR_En in a VTEM packet of the HDMI source. The VTEM packet is described hereafter with reference to FIG. 5.

If the HDMI source has variable refresh rate, the electronic apparatus 100 may proceed with the above-described operation of adjusting refresh rate of a sub image. If the HDMI source does not have variable refresh rate, a multi-view operation in an ordinary case may proceed.

Meanwhile, in the case where the HDMI source has variable refresh rate, the electronic apparatus 100 may check whether refresh rate of the sub source is greater than minimum refresh rate of the main source (S440). Specifically, the electronic apparatus 100 may obtain maximum refresh rate and minimum refresh rate of the main source, and check the minimum refresh rate, and the refresh rate of the sub source. Meanwhile, in the case where a plurality of sub sources is provided, the electronic apparatus 100 may compare the greatest of all the refresh rate of the plurality of sub sources with the minimum refresh rate.

If the refresh rate of the sub source is greater than the minimum refresh rate (S440_Y), the electronic apparatus 100 may update the minimum refresh rate of the main source (S460). For example, the electronic apparatus 100 may change the minimum refresh rate of the main source to the refresh rate of the sub source by performing communication with a source provider providing the main source. Meanwhile, in the case of a plurality of sub sources, the electronic apparatus 100 may change the minimum refresh rate to the greatest of all the refresh rate of the plurality of sub sources.

If the refresh rate of the sub source is the same as or less than the minimum refresh rate, the electronic apparatus 100 may use existing minimum refresh rate as it is.

Meanwhile, the process of updating minimum refresh rate of a main source based on refresh rate of a sub source is described above, but when implemented, the refresh rate of the sub source may be adjusted. For example, in the case where the refresh rate of the sub source is greater than the minimum refresh rate of the main source, the electronic apparatus 100 may request the sub source to provide an image with the minimum refresh rate of the main source to receive the sub source with adjusted refresh rate.

In the case where the above-described settings are completed, the electronic apparatus 100 may perform a multi-view generating operation based on current refresh rate of variable refresh rate.

Specifically, the electronic apparatus may check refresh rate of a current main image by analyzing a VTEM packet (S470). Herein, the VTEM packet may include information on minimum refresh rate (or a minimum refresh rate), maximum refresh rate (or a maximum refresh rate), current refresh rate (or a current refresh rate) and the like. An example of the VTEM packet is described hereafter with reference to FIG. 5.

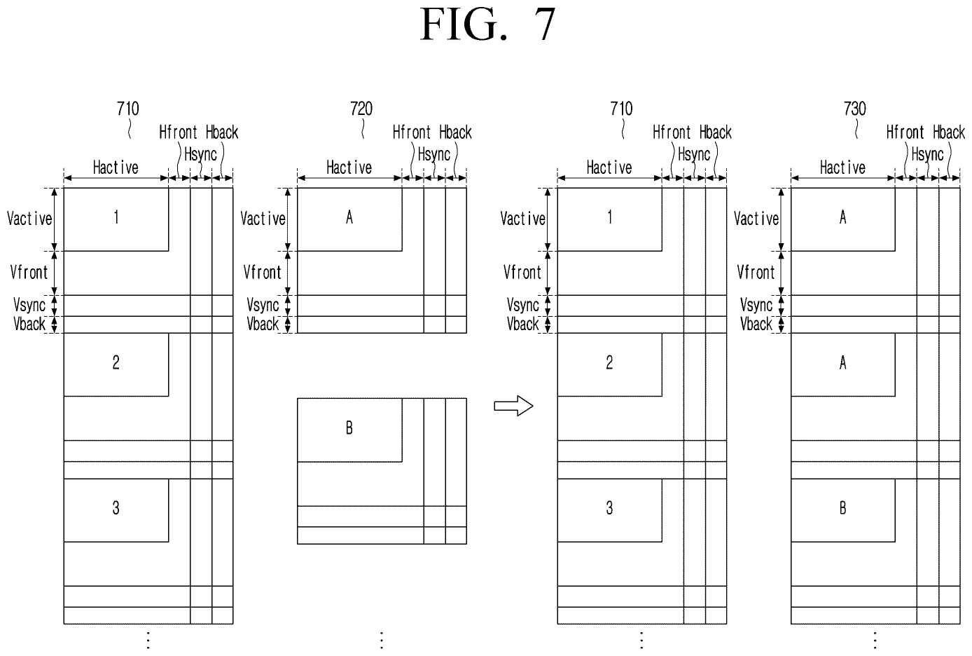

Based on checking the current refresh rate of the main image, the electronic apparatus 100 may make refresh rate of a sub image identical with the refresh rate of the main image by disposing a frame of the sub image repeatedly (S480). Additionally, the electronic apparatus 100 may perform synchronization of resolution of the images. Synchronization of refresh rate is specifically described with reference to FIG. 7, and synchronization of resolution is specifically described with reference to FIGS. 8 and 9.

In the case where a multi-view screen is generated based on the above-described operations, the generated multi-view screen may be displayed or transmitted to another device (S490).

FIG. 5 is a view provided to explain a structure of a VTEM packet.

The VTEM is a function adopted according to a high-definition multimedia interface (HDMI) 2.1 standard. The variable refresh rate may be controlled by using the VTEM.

Referring to FIG. 5, VRR_En in a packet is bit information for differentiating an operation with variable refresh rate. For example, in the case where the VRR_En value is 1, variable refresh rate is being applied, while in the case where the value is 0, the variable refresh rate is not being applied.

Additionally, Base_Vfront, as a vertical front porch (VFP), is a blank section until a Vsync signal starts, and during this section, new image data are not transmitted to a screen, and a display may prepare a following frame by using this time.

Additionally, Base_Refresh_Rate, as basic refresh rate before a start of variable refresh rate, may be used in the case where the display sets optimal refresh rate.

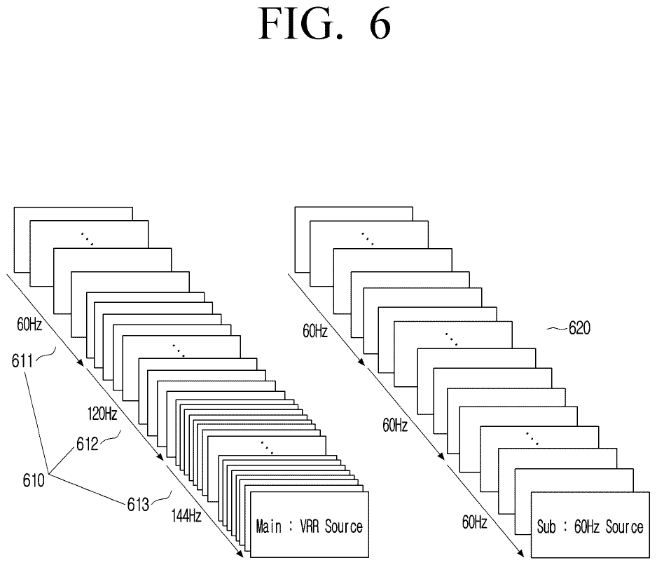

FIG. 6 is a view provided to explain a difference between an image of variable refresh rate and an image of fixed refresh rate according to one embodiment.

Referring to FIG. 6, the first image and the second image are illustrated. Herein, the first image, as an image having variable refresh rate, has a refresh rate range of 144 Hz-60 Hz in the illustrative example (610). The first image described above may be received through an HDMI port. For example, it may turn out that in a first section, the first image has refresh rate of 144 Hz and then has refresh rate of 120 Hz, and later, the refresh rate of the first image is changed to refresh rate of 60 Hz.

The second image, as an image having fixed refresh rate, the second image has refresh rate of 60 Hz in the illustrative example (620). It may turn out that unlike the first image having variable refresh rate, the second image having fixed refresh rate has identical refresh rate in an entire section.

The second image described above may be an image that is received through an HDMI port different from the HDMI port through which the first image is received, or is received through a USB 3.1 port, or is obtained based on the Internet or a broadcasting signal.

In the illustrative example, the refresh rate of the second image is not greater than minimum refresh rate of the first image, that is, the refresh rate of the second image may be identical with the minimum refresh rate. Accordingly, an operation of changing the minimum refresh rate of the first image may not be performed. If the refresh rate of the second image is greater than the minimum refresh rate of the first image, the minimum refresh rate of the first image may be adjusted preceding.

In the case where the first image and the second image are input to the electronic apparatus 100 as described above, since the refresh rate of the second image in the 144 Hz-120 Hz section of the first image is 60 Hz, so there is no synchronization between the two sources.

Accordingly, the electronic apparatus 100 may generate a multi-view screen having refresh rate of 144 Hz by changing the refresh rate of the second image from 60 Hz to 144 Hz in the 144 Hz section of the first image (613).

Additionally, the electronic apparatus 100 may generate a multi-view screen having refresh rate of 120 Hz by changing the refresh rate of the second image from 60 Hz to 120 Hz in the 120 Hz section of the first image (612).

Further, since the refresh rate of the two images is identical in the 60 Hz section of the first image, the electronic apparatus 100 may generate a multi-view screen having refresh rate of 60 Hz without changing the refresh rate of the second image (611).

Hereafter, an operation of generating a multi-view screen in the 120 Hz section of the first image is specifically described with reference to FIG. 7.

FIG. 7 is a view provided to explain a method of synchronizing refresh rate according to one embodiment.

Referring to FIG. 7, a first image 710 and a second image 720 are displayed. Herein, the first image is currently operating at 120 Hz, and the second image is currently operating at refresh rate less than 120 Hz.

In the case where the first image and the second image have different refresh rate as described above, the electronic apparatus 100 may allow the second image 730 to synchronize with the first image 710 by disposing a specific frame of the second image repeatedly. If the first image is currently operating at 120 Hz while the second image is currently operating at 60 Hz, the electronic apparatus may arrange each frame of the second image twice to match the 120 Hz refresh rate.

Meanwhile, in FIG. 7, the synchronization performed simply by repeating disposition of the second image is illustrated and described, but frame interpolation may be applied to intermediate frames instead of repeating the same frame multiple times as described above.

Herein, the frame interpolation, as a task of uploading a frame of a moving image or a real-time rendering image, may lead to a significant reduction in an existing phenomenon such as shaking and the like of a moving image screen and secure a natural display of a screen. For example, during the frame interpolation, a frame doubling technology, a frame generating technology, a motion interpolation technology and the like may be used.

Additionally, the electronic apparatus may perform synchronization while the electronic apparatus changes a vertical front porch Vfront value of a sub source, that is, may perform synchronization by making a Vsync start time point of a main source identical with a Vsync start time point of a sub source.

Based on the above-described operation, synchronization of operation time points of the first image 710 and the second image 730 of which the refresh rate is changed may be performed as illustrated in the right area of FIG. 7.

Hereafter, an operation of changing resolution of two images is described. Specifically, in a multi-view screen, a size of one of the two images is adjusted and displayed without displaying each of the images on the screen as it is. The operation is described hereafter with reference to FIG. 8.

Meanwhile, the performance of the adjustment of the operation time point and the adjustment of the resolution after the adjustment of the operation time point are illustrated and described above, but when implemented, the synchronization of the refresh rate after the adjustment of the resolution may be performed. Additionally, when implemented, in the above-described multi-view generating process, the synchronization of the resolution and the synchronization of the refresh rate (or a refresh rate) may also be performed at the same time.

FIG. 8 is a view provided to explain a multi-view generating operation from a resolution perspective according to one embodiment.

Referring to FIG. 8, the electronic apparatus 100 includes an image processing device 830, and receives a first image 810 and a second image 820.

Herein, the first image 810 may be an image that has refresh rate of 120 Hz and resolution of 4K currently. Additionally, the second image 820 may be an image that has refresh rate of 60 Hz and resolution of 2K.

In the case where the above-described first image 810 and second image 820 are input, the image processing device 830 may generate a multi-view screen having resolution of 4K and refresh rate of 120 Hz. The refresh rate of the multi-view screen may remain the same as the refresh rate of the first image as described above, but the resolution of the multi view screen may use the greater or less resolution of the two images or may use resolution (e.g., resolution selected by the user) totally different from those of the two images.

To this end, the image processing device 820, as described with reference to FIG. 7, may arrange the second image repeatedly such that the second image may have refresh rate of 120 Hz, and in this process, may upscale the resolution of the second image from 2K to 4K such that the resolution of the second image may correspond to the resolution of the multi view. In the case where the first image and the second image have 120 Hz as described above, the resolution of the first image and the resolution of the second image may be matched as 4K.

For example, in the case where HDMI VRR is input to a main source, the image processing device 830 may synchronize resolution of a sub source based on HDMI infoframe information, and check current refresh rate of a VTEM packet of an HDMI and perform synchronization of a refresh rate of the sub source.

At this time, image quality and screen quality may be processed based on an increase or a decrease in the Vfront section with respect to reference Hz of the main source.

The above-described multi-view screen may be transmitted to a timing controller 145 of the display 140.

The timing controller 145 may provide the multi-view screen to each pixel at a time point of 120 Hz. Specifically, the timing controller 145 may provide the received multi-view screen to a display panel by using VRR settings set to be appropriate to a characteristic of the display panel.

Accordingly, the multi-view screen 860 may display a first image 840 on the left side thereof, and a second image 850 on the right side thereof.

Meanwhile, resolution of two screens is matched at high resolution in the above description, but when implemented, may be matched at low resolution. Description in relation to this is provided hereafter with reference to FIG. 9.

FIG. 9 is a view provided to explain a multi-view generating operation from a resolution perspective according to one embodiment.

Referring to FIG. 9, the electronic apparatus 100 includes an image processing device 930, and receives a first image 910 and a second image 920.

Herein, the first image 910 may be an image that has refresh rate of 120 Hz and resolution of 4K currently. Additionally, the second image 920 may be an image that has refresh rate of 60 Hz and resolution of 2K.

In the case where the above-described first image 910 and second image 920 are input, the image processing device 930 may generate a multi-view screen having resolution of 2K and refresh rate of 120 Hz. When implemented, the resolution of the multi-view screen may use resolution selected by the user rather than 2K.

To this end, the image processing device 930, as illustrated in FIG. 7, may arrange the second image repeatedly such that the second image may have refresh rate of 120 Hz, and in this process, may downscale the resolution of the first image from 4K to 2K. In the case where the first image and the second image have 120 Hz as described above, the resolution of the first image and the second image may be matched as 2K.

The above-described multi-view screen may be transmitted to the timing controller 145 of the display 140. The timing controller 145 may provide the multi-view screen to each pixel at a time point of 120 Hz. Accordingly, the multi-view screen 960 may display a first image 940 on the left side thereof, and display a second image 950 on the right side thereof.

As described above, the multi-view screen generated according to the present disclosure has the same resolution and the same refresh rate, and thus, even in a case where a display includes only one TCON (Timing Controller), it is possible to display a multi-view screen with a variable refresh rate. Additionally, even in the case where a display area of each TCON differs from a display area of each screen in a multi view in a display device having a plurality of TCONs, a multi-view screen may be displayed, securing improvement in user experience.

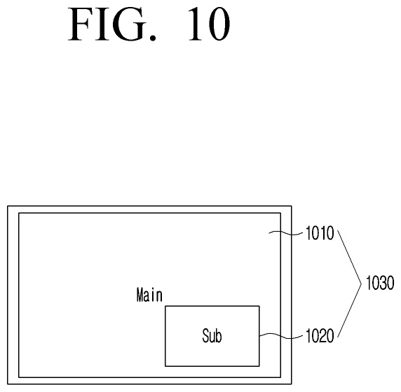

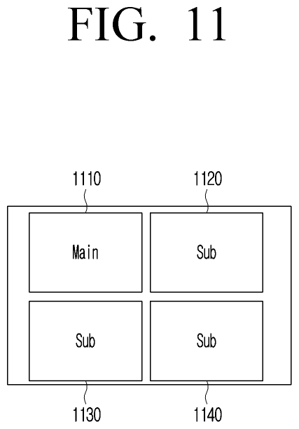

Meanwhile, the configuration example of a multi-view screen where out of two images, one image is displayed on the left side and the other is displayed on the right side is illustrated above, but when implemented, is not limited thereto. Another configuration example is described hereafter with reference to FIG. 10 and FIG. 11.

FIG. 10 is a view provided to explain a multi-view disposing structure according to one embodiment.

Referring to FIG. 10, a multi-view screen 1030 may include a main area 1010 and a sub area 1020. The multi-view screen 1030 may have a PIP form as illustrated.

The main area 1010 is an area in which an entire screen is basically used. For example, a first image having variable refresh rate may be displayed in the main area 1010.

The sub area 1020 may be disposed in a portion of the lower end of the right side of the main area, and a sub image may be scaled to correspond to a size of the main area. For example, a second image having fixed refresh rate may be displayed in the sub area 1020. When implemented, the sub area 1020 may also be disposed at the upper end of the right side of the main area, at the upper end of the left side thereof, or at the lower end of the left side thereof, instead of the lower end of the right side thereof.

For example, in the case where the user proceeds with a game and films the user for broadcasting, the user may receive an image having variable refresh rate from a PC or a game console through an HDMI port. At this time, the user may receive an image where the user is filmed through a USB 3.1 port and display the image on the sub area 1020. When implemented, a broadcast screen transmitted from a broadcasting station may be displayed in the sub area 1020, or streaming images may be displayed in the sub area 1020.

Meanwhile, when implemented, the main area may display the second image based on selection of the user in addition to displaying the first image. For example, even in the case where the first image is displayed in the main area while the second image is displayed in the sub area as illustrated in FIG. 10, the second image may be displayed in the main area while the first image may be displayed in the sub area according to a disposition transition instruction of the user. Additionally, based on the disposition transition instruction of the user, disposition in the PIP form may be changed such that two images are displayed in a layout where the two images are disposed in the left-right direction as illustrated in FIG. 8 or FIG. 9.

FIG. 11 is a view provided to explain a multi-view disposing structure according to one embodiment.

Referring to FIG. 11, a multi-view screen may be divided into four areas 1110, 1120, 1130, 1140.

Among the four areas, a first area 1110 may be a main area while a second area 1120, a third area 1130 and a fourth area 1140 may be sub areas. Accordingly, in FIG. 11, four images may be displayed at the same time. At this time, a first image displayed in the first area may be an image having variable refresh rate, while the second to fourth images displayed in the second-fourth areas may be images having fixed refresh rate.

In the case where two or more sub images are provided as described above, the electronic apparatus 100 may compare minimum refresh rate of the first image with refresh rate of the sub images to check whether the refresh rate of at least one of the sub images is greater than the minimum refresh rate. If the refresh rate of at least one of the sub images is greater than the minimum refresh rate, the electronic apparatus 100 may update the minimum refresh rate of the first image to the greatest of all the refresh rate of the sub images.

Additionally, the electronic apparatus 100 may change the refresh rate of each of the images to match current refresh rate of the first image. Meanwhile, in the case where all the sub images have identical refresh rate, synchronization of each sub image may proceed in an identical pattern. If the refresh rate of each sub image differs, a synchronization method for each sub image may differ, but the sub images finally synchronized may have refresh rate identical with refresh rate of the image having variable refresh rate.

Meanwhile, in the illustrative example, the first area 1110 is referred to as a main area, but when implemented, the other areas 1120, 1130, 1140 may be main areas. Additionally, when implemented, the multi-view screen may be divided into three areas only or into five or more areas.

FIG. 12 is a view provided to explain a multi-view displaying operation in a case where a plurality of TCONs is provided according to one embodiment.

Referring to FIG. 12, a display 140 may include a plurality of timing controllers 145-1, 145-2.

For example, a first timing controller 145-1 may be a timing controller controlling the left area of the display, while a second timing controller 145-2 may be a timing controller controlling the right area of the display.

In the case where a plurality of timing controllers is provided as described above, considering that each of the timing controllers may operate individually, a first image may be displayed with first refresh rate by using the first timing controller 145-1, and a second image may be displayed by using the second timing controller 145-2. In this case, the two timing controllers may operate with identical refresh rate, or may operate with different refresh rate. Accordingly, each of the images may constitute a multi-view screen 1210 individually although the refresh rate of each of the images is not adjusted.

However, there are limitations on a method of controlling each area of the above-described multi-view screen with an individual timing controller. In particular, since the control area of a timing controller is fixed physically, a timing controller may not be added or the control area may not be changed, later.

Accordingly, in the case where the first image needs to be displayed as a main image while the second image needs to be displayed in the PIP form as illustrated in FIG. 10, the first timing controller 145-1 may operate according to an operation frequency of the first image, but considering that the second timing controller 145-2 needs to display two images of different operation frequencies, the second timing controller 145-2 may not operate.

Additionally, even in the case where three images or four images are displayed as illustrated in FIG. 11, considering that at least one timing controller needs to display images operating at different frequencies, the at least one timing controller may not operate.

Even in the case where a plurality of timing controllers is provided as described above, based on synchronizing an entire area of a multi-view screen to have identical refresh rate and identical resolution according to the disclosure, various layouts and multiple numbers of multi-view screen may be displayed regardless of the area of a timing controller, despite limitations of the configuration of the multi-view screen.

For example, in the case where the first image has an operation range of 144-60 Hz and the second image has 60 Hz, while the first image has current refresh rate of 120 Hz, a multi-view screen may have 120 Hz. Accordingly, the first timing controller 145-1 may display the left area of the multi-view screen with 120 Hz. Additionally, the second timing controller 145-2 may display the right area of the multi-view screen with 120 Hz.

FIG. 13 is a view provided to explain a multi-view displaying operation in a case where a plurality of TCONs is provided according to one embodiment.

Referring to FIG. 13, a display 140 may include a plurality of timing controllers 145-1, 145-2.

For example, a first timing controller 145-1 may be a timing controller controlling an image in the left area of the display, while a second timing controller 145-2 may be a timing controller controlling an image in the right area of the display.

In the above-described disposition, it may be assumed that a multi-view screen 1310 is displayed such that a first image may be displayed as a main image 1320 while a second image may be displayed in the PIP form as a sub image 1330, as illustrated in FIG. 13.

In the case where the subject matter of the present disclosure is not applied, since the first timing controller 145-1 displays part of the first image only, the first timing controller 145-1 may operate according to refresh rate of the first image. However, the second timing controller 145-5 needs to display part of the first image and the second image together, but may not operate since the refresh rate of the two images differs.

In the case where refresh rate and resolution of two images are synchronized according to the disclosure, since part of a first image and a second image to be displayed by the second timing controller 145-5 may have identical refresh rate and identical resolution, the second timing controller 145-5 may operate.

For example, in the case where the first image has an operation range of 144-60 Hz and the second image has 60 Hz, while the first image has current refresh rate of 120 Hz, a multi-view screen may have 120 Hz. Accordingly, the first timing controller 145-1 may display the left area of the multi-view screen with 120 Hz. Additionally, the second timing controller 145-2 may display the right area of the multi-view screen with 120 Hz.

Meanwhile, the operation with a plurality of timing controllers in the case where one has variable refresh rate while the other has fixed refresh rate is described with reference to FIG. 12 and FIG. 13. However, when implemented, this may also be applied to images having two or more variable refresh rate in the case where a plurality of timing controllers is provided.

For example, in the case where a screen illustrated in FIG. 12 is displayed, a first image having variable refresh rate may be displayed by using the first timing controller 145-1, while a second image having variable refresh rate may be displayed by using the second timing controller 145-2.

At this time, in the case where a third image is added, the electronic apparatus 100 may synchronize refresh rate of the third image with refresh rate of one of the first image or the second image. Accordingly, in the case where the third image is synchronized with the first image, a multi-view screen of the first image and the third image may be displayed with first refresh rate by the first timing controller 145-1, and the second image may be displayed with second refresh rate by the second timing controller 145-2.

Further, in the case where a fourth image is added, refresh rate of the fourth image may be synchronized with the refresh rate of the second image, and a multi view of the second image and the fourth image may also be displayed with the second refresh rate by the second timing controller 145-2.

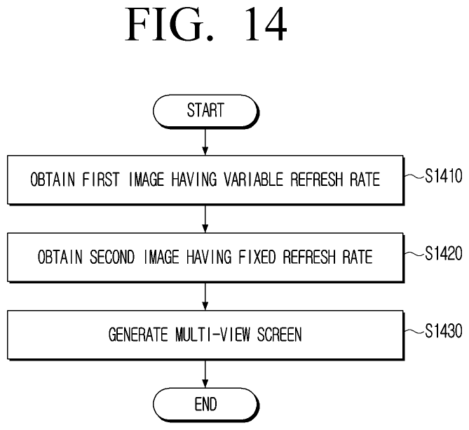

FIG. 14 is a flowchart provided to explain a control method of an electronic apparatus according to one embodiment.

Referring to FIG. 14, in the case where a multi-view displaying instruction is input, a first image having variable refresh rate is obtained (1410). For example, while displaying an image with a variable refresh rate, a multi-view display command may be received, and another second image to be displayed together may be additionally selected.

On the contrary, the multi-view displaying instruction may be received from the user while a second image having fixed refresh rate is displayed, and an image having variable refresh rate may be additionally selected and received. The above-described first image may also be obtained based on an interface method such as an HDMI.

Additionally a second image having fixed refresh rate is obtained (1420). Herein, the second image may be an image obtained through an HDMI port different from a port through which the above-described first image is obtained, and may also be an image obtained through a USB 3.1 terminal, or a streaming image obtained through an Internet network, or an image pre-stored in an electronic apparatus or an image obtained through a broadcasting network (i.e., an image obtained through a tuner).

In the case where a multi-view instruction of the first image having variable refresh rate and the second image having fixed refresh rate is input as described above, the electronic apparatus may check a refresh rate range of the first image. Herein, the refresh rate range may be maximum refresh rate and minimum refresh rate. The above-described refresh rate range may be found based on frame frequency information in a VTEM packet.

Meanwhile, in the case where the first image is input through an HDMI terminal, the electronic apparatus may previously check whether the first image has variable refresh rate or not by using VRR_en in the above-described VTEM packet. That is, the operations according to the disclosure may be applied based on checking that the first image operates with variable refresh rate.

In the case where a refresh rate of the second image is greater than a minimum value of the variable refresh rate checked in the above-described process, an adjustment of a variable range of the HDMI terminal may proceed. For example, in the case where information on which the first image operates in a 144 Hz-50 Hz range is obtained through the VTEM packet, and the second image operates with 60 Hz, the electronic apparatus may adjust the variable range to 144 Hz-60 Hz based on communication with a source provider providing the first image.

Based on the adjustment described above, the variable range of the first image may be changed to 144 Hz-60 Hz.

In the state where the minimum refresh rate is greater than the refresh rate of the second image as described above, the electronic apparatus 100 may generate a multi-view screen by using the first image and the second image. The above-described generation of the multi-view screen may involve an operation of changing refresh rate and resolution.

First, the electronic apparatus may check current refresh rate of the first image based on information of frequencies in the above-described VTEM packet, and adjust a frequency of the second image to correspond to the checked frequency. That is, the multi-view screen may be generated such that refresh rate of the generated multi-view screen may correspond to the refresh rate of the first image.

For example, in the case where the refresh rate of the first image is changed like this (144 Hz->120 Hz->60 Hz), the multi-view screen may also be changed like this (144 Hz->120 Hz->60 Hz), and the frame of the second image may be arranged repeatedly such that the refresh rate of the second image may be adjusted to correspond to the current refresh rate of the first image.

At this time, the electronic apparatus may synchronize a Vsync start time point of the first image and a Vsync start time point of the second image by adjusting a vertical front porch Vfront of the second image. Based on the above-described process, the occurrence of flickers in the multi-view screen may be prevented.

Meanwhile, in the above-described process of generating a multi-view screen, the electronic apparatus may synchronize resolution as well as a frequency. Specifically, the electronic apparatus may determine resolution of the multi-view screen, and in response to the determined resolution of the multi view screen, may scale at least one of resolution of the first image and resolution of the second image.

Meanwhile, in the case where the electronic apparatus includes a display, the electronic apparatus may provide the generated multi-view screen to the display to display the multi-view screen. At this time, the display may include only one timing controller. Even in the case where two images operating at a different frequency are displayed as a multi view as described above, the display provided with one timing controller may also display the multi view, since in the process, the electronic apparatus processes the two images such that the two images may have one frequency.

Additionally, the above-described display may be provided with a plurality of timing controllers. In the case where the display is provided with the plurality of timing controller as described above, one timing controller may display the first image, while another timing controller may display the second image. However, in this case, the images need to be displayed at an identical ratio, making it impossible to apply a multi view where images are displayed in a PIP method or where three or more screens are displayed at the same time.

However, based on matching the operation frequencies of the two images in the above-described method, a normal operation may be possible in the case where two images are displayed in the PIP form, or where three or more images are displayed at a time, that is, in the case where one timing controller needs to use both of first and second images since the two images are disposed vertically.

Meanwhile, in the case where the electronic apparatus does not include a display, the electronic apparatus may output a multi-view screen to another port rather than a port to which a first image is input, or may receive a first image in a wired manner while providing a multi-view screen to a receiver device or a display device in a wireless manner.

According to the control method of the disclosure, a normal operation may be possible as described above, even in the case where an image corresponding to at least one screen constituting a multi view has variable refresh rate, while the multi view displaying a plurality of images is displayed.

Meanwhile, the methods according to at least part of the above-described embodiments of the disclosure may be implemented in the form of an application that is installable in an existing electronic apparatus.

Additionally, the methods according to at least part of the above-described embodiments of the disclosure may be implemented merely by upgrading software or hardware of an existing electronic apparatus.

Additionally, the methods according to at least part of the above-described embodiments of the disclosure may be performed through an embedded server provided in an electronic apparatus, or an external server of at least one of electronic apparatuses.

Meanwhile, the embodiments described above may be implemented with software including instructions stored in a storage medium readable by a machine (e.g., a computer). The machine, as a device capable of calling the stored instructions from the storage medium and operating according to the called instructions, may include the electronic apparatus (e.g., electronic apparatus (A)) according to the disclosed embodiments. Based on instructions executed by a processor, the processor may perform functions corresponding to the instructions directly or by using other elements under the control of the processor. The instructions may include a code generated or executed by a compiler or an interpreter. The machine-readable storage medium may be provided in the form of a non-transitory storage medium. Herein, the “non-transitory storage medium” only means a tangible device and means including no signal (e.g., electromagnetic waves) while the term does distinguish semi-permanent or temporary storage of data in the storage medium. For example, the “non-transitory storage medium” may include a buffer where data are temporarily stored. According to one embodiment, the methods according to the embodiments set forth herein may be provided in a computer program product. The computer program product may be exchanged between a seller and a purchaser as a commodity. The computer program product may be distributed in the form of a machine-readable storage medium (e.g., compact disc read only memory (CD-ROM)), or distributed (e.g., downloaded or uploaded) online through an application store (e.g., Play Store™) or directly between two user devices (e.g., terminal devices). In the case of online distribution, at least part of the computer program product (e.g., a downloadable app) may be stored at least temporarily, or generated temporarily in a machine-readable storage medium such as a server of a manufacturer, a server of an application store, or memory of a relay server.

The embodiments set forth herein may be implemented with software including instructions stored in a storage medium readable by a machine (e.g., a computer). The machine, as a device capable of calling the stored instructions from the storage media and operating according to the called instructions, may include the electronic apparatus (e.g., an electronic apparatus 100) according to the disclosed embodiments.

Based on the above-described instructions executed by a processor, the processor may perform functions corresponding to the instructions directly or by using other elements under the control of the processor. The instructions may include a code generated or executed by a compiler or an interpreter.

While the example embodiments of the disclosure are illustrated and described above, embodiments of the disclosure are not limited to the embodiments set forth herein, and certainly, various modifications thereof may be made by those skilled in the art to which the disclosure pertains, without departing from the scope the disclosure claimed in the section of claims, and are not to be understood as separating from the technical spirit or prospect of the disclosure.

1. An electronic apparatus comprising:
an input/output interface;
memory configured to store at least one instruction; and
at least one processor configured to execute the at least one instruction to:
obtain a first image having a variable refresh rate through the input/output interface,
obtain a second image having a fixed refresh rate, and
generate a multi-view screen displaying both the first image and the second image by changing the fixed refresh rate of the second image to a current refresh rate of the first image.

2. The electronic apparatus as claimed in claim 1, wherein based on the fixed refresh rate of the second image being greater than a minimum refresh rate of the variable refresh rate of the first image, the at least one processor is configured to execute the at least on instruction to:
change the minimum refresh rate of the variable refresh rate of the first image.

3. The electronic apparatus as claimed in claim 1, wherein the at least one processor is further configured to execute the at least one instruction to:
generate the multi-view screen such that a refresh rate of the multi-view screen changes to the current refresh rate of the first image.

4. The electronic apparatus as claimed in claim 1, wherein the at least one processor is further configured to execute the at least one instruction to:
synchronize the fixed refresh rate of the second image such that the fixed refresh rate of the second image changes to the current refresh rate of the first image by disposing a frame of the second image repeatedly.

5. The electronic apparatus as claimed in claim 1, wherein the at least one processor is further configured to execute the at least one instruction to:
synchronize a Vsync start time point of the first image with a Vsync start time point of the second image by adjusting a vertical front porch Vfront of the second image.

6. The electronic apparatus as claimed in claim 1, wherein the at least one processor is further configured to execute the at least one instruction to:
determine resolution of the multi-view screen, and
scale at least one of resolution of the first image and resolution of the second image, in response to the determined resolution of the multi-view screen.

7. The electronic apparatus as claimed in claim 1 further comprising:
a display configured to display an image by using a timing controller,
wherein the at least one processor is configured to execute the at least one instruction to:
control the timing controller to display the multi-view screen.

8. The electronic apparatus as claimed in claim 1 further comprising:
a display configured to display an image by using a plurality of timing controllers,
wherein the at least one processor is configured to execute the at least on instruction to:
change the fixed refresh rate of the second image based on at least one timing controller among the plurality of timing controllers processing the first image and the second image together.

9. The electronic apparatus as claimed in claim 8, wherein the at least one processor is further configured to execute the at least one instruction to:
generate the first image and the second image as a multi view in a picture in picture (PIP) form.

10. The electronic apparatus as claimed in claim 1, wherein the at least one processor is further configured to execute the at least one instruction to:
obtain the current refresh rate of the first image based on refresh rate information in a video timing extended metadata (VTEM) packet obtained through the input/output interface.

11. A method of controlling an electronic apparatus, the method comprising:
obtaining a first image having a variable refresh rate;
obtaining a second image having a fixed refresh rate; and
generating a multi-view screen displaying both the first image and the second image, by changing the fixed refresh rate of the second image to a current refresh rate of the first image.

12. The method as claimed in claim 11, wherein the generating generates the multi-view screen such that a refresh rate of the multi-view screen is changed to the current refresh rate of the first image.

13. The method as claimed in claim 11, wherein the generating includes:
synchronizing the fixed refresh rate of the second image such that the fixed refresh rate of the second image changes to the current refresh rate of the first image by disposing a frame of the second image repeatedly.

14. The method as claimed in claim 11, wherein the generating includes:
synchronizing a Vsync start time point of the first image with a Vsync start time point of the second image by adjusting a vertical front porch Vfront of the second image.

15. A non-transitory computer-readable recording medium in which a program for executing a method of controlling an electronic apparatus is stored, the method comprising:
by the electronic apparatus:
obtaining a first image having a variable refresh rate;
obtaining a second image having a fixed refresh rate; and
generating a multi-view screen displaying both the first image and the second image, by changing the fixed refresh rate of the second image to a current refresh rate of the first image.
